(19) United States
(12) Patent Application Publication
(10) Pub. No.: US 2018/0152612 A1
(43) Pub. Date: May 31, 2018

(54) IMAGING DEVICE, CONTROL METHOD THEREOF, AND RECORDING MEDIUM

(71) Applicant: Olympus Corporation, Tokyo (JP)

(72) Inventors: Yasunori KUDO, Tokyo (JP); Tetsuo KIKUCHI, Tokyo (JP); Satoshi HARA, Tokyo (JP)

(21) Appl. No.: 15/796,738

(22) Filed: Oct. 27, 2017

(30) Foreign Application Priority Data
Nov. 25, 2016 (JP) 2016-229352

(51) Int. Cl. H04N 5/235; H04N 5/232; H04N 5/222

(52) U.S. Cl. CPC H04N 5/2352; H04N 5/2226; H04N 5/23212; H04N 5/23293

(57) ABSTRACT

An imaging device includes an image sensor that converts a subject image formed by a photographing lens into an electrical signal and outputs the electrical signal, a mechanical shutter that controls the image sensor to be in a light-shielding state or in an exposed state, and a display device that performs a live-view display according to an output of the image sensor. The imaging device causes the image sensor to start imaging of a live view after photographing a still image, detects that the mechanical shutter is in a fully open state, after the start of the imaging, and performs a ranging operation or the like according to the output of the image sensor obtained by imaging the live view, after the detection.

### CROSS-REFERENCE TO RELATED APPLICATIONS

This application is based upon and claims the benefit of priority of the prior Japanese Patent Application No. 2016-229352, filed Nov. 25, 2016, the entire contents of which are incorporated herein by reference.

### FIELD

The present invention relates to an imaging device that performs still-image photographing by using a mechanical shutter, a control method thereof, and a recording medium.

### BACKGROUND

Conventionally, as an example of an imaging device, a digital single-lens reflex camera is known.

The digital single-lens reflex camera generally includes a focal-plane shutter (hereinafter also simply referred to as a “shutter”), and an exposure time of still-image photographing is controlled by the shutter. The digital single-lens reflex camera also includes a function called a live view for displaying an image formed on an image sensor on a display device, and framing is performed by using the function.

In the digital single-lens reflex camera above, ranging, photometry, or subject analysis such as person recognition, is performed during the live view, and the position of a lens and an exposure amount in still-image photographing are determined. Here, it is important to rapidly switch still-image photographing and the live view in order to frame a moving subject.

As an example of the digital single-lens reflex camera, the following camera is known. In this camera, an aperture of a shutter device starts to open from a shielded state toward a fully open state, and when the aperture enters into a state in which the aperture is open by a prescribed amount before the aperture is fully open, an image signal starts to be captured from an image sensor, and the operation of focusing means and the operation of exposure determination means are performed (see, for example, Japanese Patent No. 5760188). It is considered that an object of this camera is that, after still-image photographing, a shutter will start to open from a closed state (a state in which the image sensor is shielded from light), and that, immediately after the shutter is driven to a position in which there is no influence from a shutter blade (hereinafter also simply referred to as a “blade”) on an image formed on the image sensor, an image signal will start to be captured from the image sensor and other operations will be performed.

### SUMMARY

In one aspect of the present invention, an imaging device is provided that includes an image sensor that forms an image with light from a subject by using a photographing lens, converts the formed image into an electrical signal, and outputs the electrical signal, and a display device that performs a live-view display according to an output of the image sensor. The imaging device includes: a mechanical shutter that controls the image sensor to be in a light-shielding state or in an exposed state; a fully open detection sensor that detects that the mechanical shutter is in a fully open state; a ranging operation circuit that performs a ranging operation according to the output of the image sensor; and a control circuit that controls the image sensor and the mechanical shutter to photograph a still image and image a live view. The control circuit controls the image sensor to start imaging of the live view after photographing the still image, and the ranging operation circuit performs the ranging operation by using the output of the image sensor obtained by imaging the live view after the fully open detection sensor has detected that the mechanical shutter is in the fully open state.

In another aspect of the present invention, an imaging device is provided that includes an image sensor that forms an image with light from a subject by using a photographing lens, converts the formed image into an electrical signal, and outputs the electrical signal, and a display device that performs a live-view display according to an output of the image sensor. The imaging device includes: a mechanical shutter that controls the image sensor to be in a light-shielding state or in an exposed state; a fully open detection sensor that detects that the mechanical shutter is in a fully open state; a photometric operation circuit that measures brightness of the subject according to the output of the image sensor; and a control circuit that controls the image sensor and the mechanical shutter to photograph a still image and image a live view. The control circuit controls the image sensor to start imaging of the live view after photographing the still image, and the photometric operation circuit performs the photometric operation by using the output of the image sensor obtained by imaging the live view after the fully open detection sensor has detected that the mechanical shutter is in the fully open state.

In yet another aspect of the present invention, a method for controlling an imaging device that includes an image sensor that converts a subject image formed by a photographing lens into an electrical signal and outputs the electrical signal, a mechanical shutter that controls the image sensor to be in a light-shielding state or in an exposed state, and a display device that performs a live-view display according to an output of the image sensor is provided. The method includes: starting, by the image sensor, imaging of a live view after photographing a still image; detecting that the mechanical shutter is in a fully open state, after the starting; and performing a ranging operation or a photometric operation according to the output of the image sensor obtained by imaging the live view, after the detecting.

In yet another aspect of the present invention, a non-transitory computer-readable recording medium storing a program for causing a computer of an imaging device to perform a process is provided. The imaging device includes an image sensor that converts a subject image formed by a photographing lens into an electrical signal and outputs the electrical signal, a mechanical shutter that controls the image sensor to be in a light-shielding state or in an exposed state, and a display device that performs a live-view display according to an output of the image sensor. The process includes: starting, by the image sensor, imaging of a live view after photographing a still image; detecting that the mechanical shutter is in a fully open state, after the starting; and performing a ranging operation or a photometric operation according to the output of the image sensor obtained by imaging the live view, after the detecting.

### BRIEF DESCRIPTION OF DRAWINGS

FIG. 1 illustrates an exemplary configuration of an imaging device according to a first embodiment.

FIG. 2A is a diagram (no. 1) explaining an example of a series of operations of a shutter unit.

FIG. 2B is a diagram (no. 2) explaining an example of a series of operations of a shutter unit.

FIG. 2C is a diagram (no. 3) explaining an example of a series of operations of a shutter unit.

FIG. 2D is a diagram (no. 4) explaining an example of a series of operations of a shutter unit.

FIG. 2E is a diagram (no. 5) explaining an example of a series of operations of a shutter unit.

FIG. 3 is a timing chart illustrating an example of the operation of the imaging device according to the first embodiment.

FIG. 4 is a flowchart illustrating an example of the operation of the imaging device according to the first embodiment.

FIG. 5 is a flowchart illustrating an example of still-image photographing processing according to the first embodiment.

FIG. 6 is a flowchart illustrating an example of still-image photographing processing according to a second embodiment.

### DESCRIPTION OF EMBODIMENTS

Embodiments of the present invention are described below in detail with reference to the drawings.

### First Embodiment

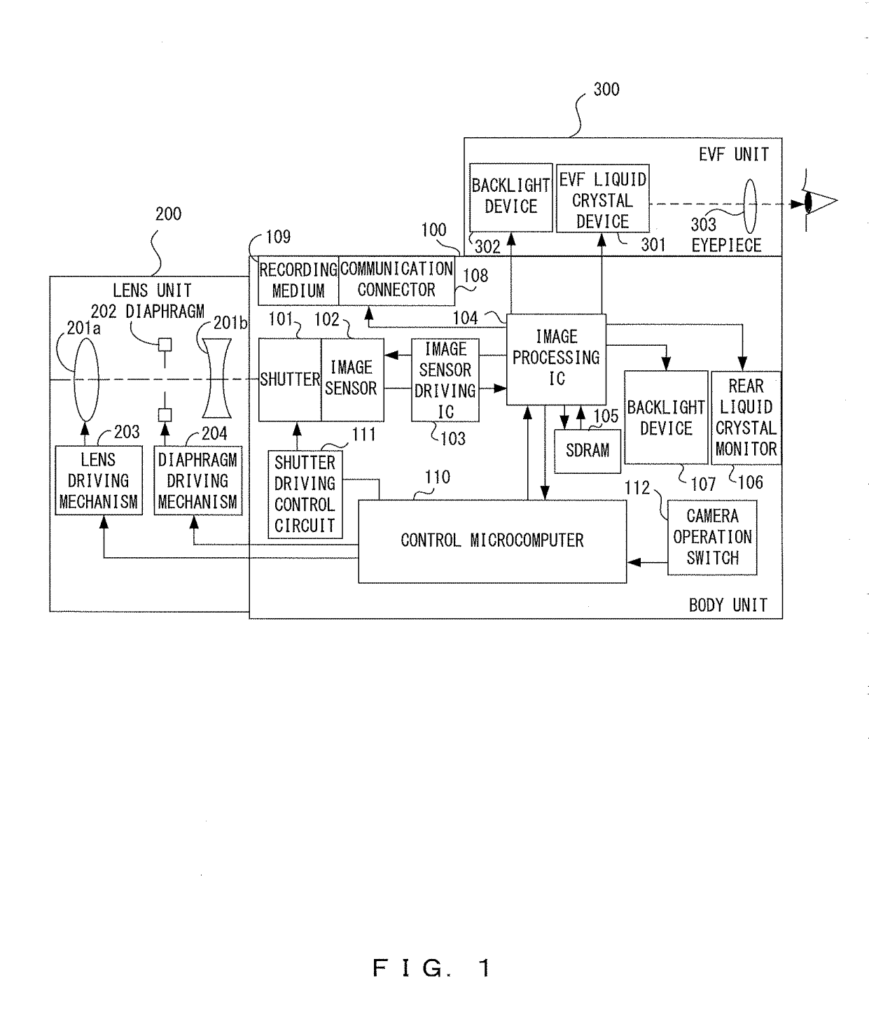

FIG. 1 illustrates an exemplary configuration of a digital camera (hereinafter simply referred to as a “camera”) that is an imaging device according to a first embodiment of the present invention.

As illustrated in FIG. 1, the camera according to this embodiment includes a body unit 100, a lens unit 200, and an EVF unit 300.

The lens unit 200 is detachable via a not-illustrated lens mount that is provided on a front face of the body unit 100, and the lens unit 200 is exchangeable in this camera.

The lens unit 200 includes a photographing lens 201 (201a and 201b), a diaphragm 202, a lens driving mechanism 203, and a diaphragm driving mechanism 204.

The photographing lens 201 is driven in an optical-axis direction by a not-illustrated direct current (DC) motor that is provided in the lens driving mechanism 203. The diaphragm 202 is driven by a not-illustrated stepping motor that is provided in the diaphragm driving mechanism 204. By driving the diaphragm 202 using the diaphragm driving mechanism 204, an amount of light that passes through the photographing lens 201 is adjusted. Respective components in the lens unit 200, such as the lens driving mechanism 203 or the diaphragm driving mechanism 204, are controlled by the control microcomputer 110 described later.

The body unit 100 has the configuration below.

A light flux from a not-illustrated subject that enters the body unit 100 via the photographing lens 201 and the diaphragm 202 within the lens unit 200 (a subject image that has passed through an optical system) passes through a shutter unit 101 in an open state, and an image is formed on an image sensor 102. The shutter unit 101 is a focal-plane shutter unit that is provided on an optical axis of the lens unit 200. The image sensor 102 performs photoelectric conversion on the formed subject image so as to generate an analog electrical signal. Photoelectric conversion performed by the image sensor 102 is controlled by an image sensor driving integrated circuit (IC) 103. The image sensor driving IC 103 converts the analog electrical signal obtained as a result of photoelectric conversion performed by the image sensor 102 into a digital electrical signal to be processed by an image processing IC 104. The image processing IC 104 converts the digital electrical signal obtained as a result of conversion performed by the image sensor driving IC 103 into an image signal.

The image processing IC 104 is connected, for example, to the image sensor 102, the image sensor driving IC 103, a synchronous dynamic random access memory (SDRAM) 105 which functions as a storage area, a rear liquid crystal monitor 106, a backlight device 107 that irradiates a liquid crystal within the rear liquid crystal monitor 106 with light from the rear, and a recording medium 109 via a communication connector 108. These components are configured so as to be able to provide an electronic recording display function in addition to an electronic imaging function. The SDRAM 105 is implemented by a commercially available memory IC.

The recording medium 109 is an external recording medium such as one of various types of semiconductor memory cards or an external hard disk drive (HDD), and the recording medium 109 is mounted so as to be communicable with the body unit 100 via the communication connector 108 and to be exchangeable.

The image processing IC 104 is also connected to the control microcomputer 110 that controls respective components within the body unit 100 and respective components within the lens unit 200. The control microcomputer 110 includes, for example, a not-illustrated timer that measures a photographing interval at the time of continuous photographing, and the control microcomputer 110 has functions of counting, mode setting, detection, determination, computation, and the like, in addition to a function of the control of the entire operation of the camera. As an example, the control microcomputer 110 causes the rear liquid crystal monitor 106 to display a report to a user (a photographer) that indicates an operation state of the camera. The control microcomputer 110 includes, for example, a CPU and a memory, and the functions of the control microcomputer 110 are implemented by the CPU executing a program stored in the memory. Specifically, the control microcomputer 110 is implemented by an application specific integrated circuit (ASIC). The control microcomputer 110 is connected to a shutter driving control circuit 111, a camera operation switch (SW) 112, a not-illustrated power source circuit, and the like.

The control microcomputer 110 and the respective components (such as the lens driving mechanism 203 or the diaphragm driving mechanism 204) of the lens unit 200 are electrically connected to each other such that a signal can be transmitted or received via a not-illustrated communication connector, by the lens unit 200 being mounted on the body unit 100.

The shutter driving control circuit 111 controls the movements of a front curtain and a rear curtain that are not illustrated in the shutter unit 101. In addition, the shutter driving control circuit 111 communicates, with the control microcomputer 110, a signal for controlling the opening/closing operation of the shutter unit 101, a signal at the time when the front curtain is fully open, a signal at the time when the rear curtain is fully open, and other signals.

The camera operation switch 112 is configured by a switch group including operation buttons needed for a user to operate the camera, such as a release switch that issues an instruction to perform a photographing operation, a mode change switch that switches a photographing mode to a continuous photographing mode, a normal photographing mode, or the like, or a power switch that switches the ON/OFF state of a power source.

The not-illustrated power source circuit converts a voltage of a not-illustrated battery serving as a power source into a voltage needed by each of the circuit units of the camera, and supplies the converted voltage.

The EVF unit 300 consists of an EVF liquid crystal device 301, a backlight device 302 that irradiates the EVF liquid crystal device 301 with light from the rear, and an eyepiece 303, and a user can view, for example, a live-view display through the eyepiece 303.

In the camera according to this embodiment, the live-view display can be displayed on both the rear liquid crystal monitor 106 and the EVF liquid crystal device 301, and a user can select which of them the live-view display will be displayed on according to the photographing situation.

A photographing operation and a live-view operation of the camera according to this embodiment are described next.

In the camera according to this embodiment, the photographing operation is performed as below.

First, the image processing IC 104 is controlled by the control microcomputer 110, and when image data (a digital electrical signal) that is output from the image sensor 102 and the image sensor driving IC 103 is input to the image processing IC 104, the image processing IC 104 stores the image data in the SDRAM 105, which is a memory for temporary storage. The SDRAM 105 is also used as a work area in which the image processing IC 104 performs image processing. In addition, the image processing IC 104 may perform image processing for converting the image data into joint photographic experts group (JPEG) data or the like, and may store the data in the recording medium 109.

Upon receipt of a signal for controlling the driving of the shutter unit 101 from the control microcomputer 110, the shutter driving control circuit 111 controls the shutter unit 101 so as to perform an opening and closing operation. At this time, prescribed image processing is performed on the image data from the image sensor 102 and the image sensor driving IC 103, and the image data is recorded in the recording medium 109 such that the photographing operation is completed.

In the camera according to this embodiment, the live-view operation is performed as below.

A light flux from the photographing lens 201 is guided to the image sensor 102. The image sensor 102 continuously performs exposure, for example, at a ratio of about 60 frames per second (60 fps). At this time, image data output from the image sensor 102 and the image sensor driving IC 103 is converted into a video signal by the image processing IC 104 and is given to the rear liquid crystal monitor 106 such that a video image of the subject can be displayed on the rear liquid crystal monitor 106. Alternatively, the video signal may be given to the EVF liquid crystal device 301 such that the video image of the subject can be displayed on the EVF liquid crystal device 301. The display above is referred to as a “live-view display”, and is well-known. Hereinafter, the “live view” or the “live-view display” may be simply referred to as an “LV”.

At the time of the LV operation, a light flux from the photographing lens 201 is always guided to the image sensor 102, and therefore the photometric processing of the brightness of the subject and known ranging processing on the subject can be performed by the image processing IC 104 on the basis of the image data output from the image sensor 102 and the image sensor driving IC 103. Hereinafter, the photometric processing of the brightness of the subject that is performed by the image processing IC 104 and the control microcomputer 110 on the basis of the image data output from the image sensor 102 and the image sensor driving IC 103, as described above, is referred to as “LV photometry”.

The shutter unit 101 in the camera according to this embodiment is described next.

The shutter unit 101 includes a front curtain, a rear curtain, a photointerrupter (PI) for the front curtain, and a PI for the rear curtain, and the shutter unit 101 has a configuration in which, when the shutter unit 101 is in the fully open state, a member provided at the end of the front curtain shields the PI for the front curtain from light and a member provided at the end of the rear curtain shields the PI for the rear curtain from light. Hereinafter, the PI for the front curtain is referred to as “PI(F)” (“F” is the initial for “First”), and the PI for the rear curtain is referred to as “PI(S)” (“S” is the initial for “Second”).

In the shutter unit 101, each of the front curtain and the rear curtain is driven according to a publicly known method. Accordingly, a method for driving a curtain is not particularly described here, but as an example, the curtain may be driven according to a general method for providing a spring in a member that moves the curtain, storing the force of the spring due to the rotational force of a motor, and releasing the force of the spring at the time of exposure. Alternatively, as described in Japanese Laid-Open Patent Publication No. 2006-047345 or Japanese Laid-Open Patent Publication No. 2014-191225, the curtain may be directly driven by an actuator at the time of exposure. In this embodiment, assume, as an example, that the curtain is driven according to a general method using a spring.

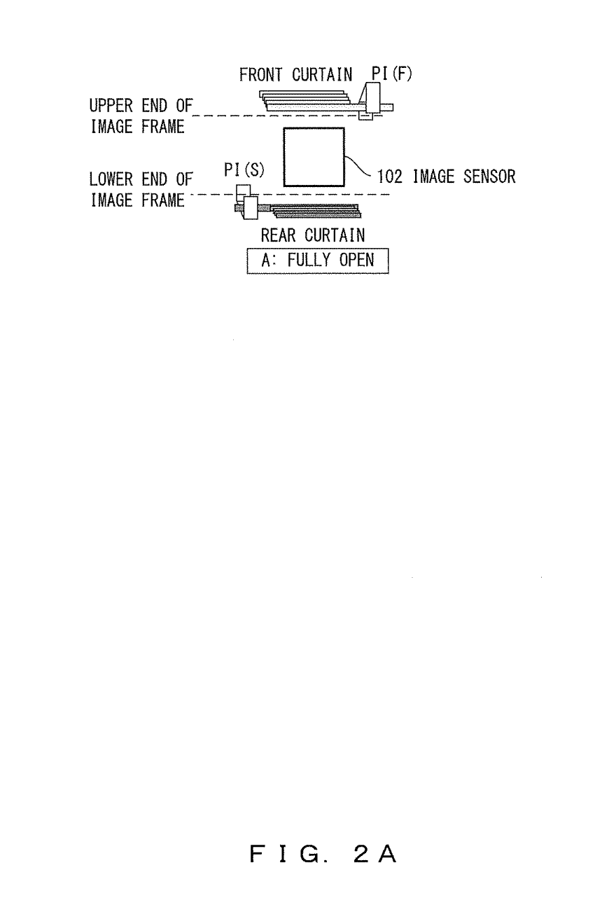

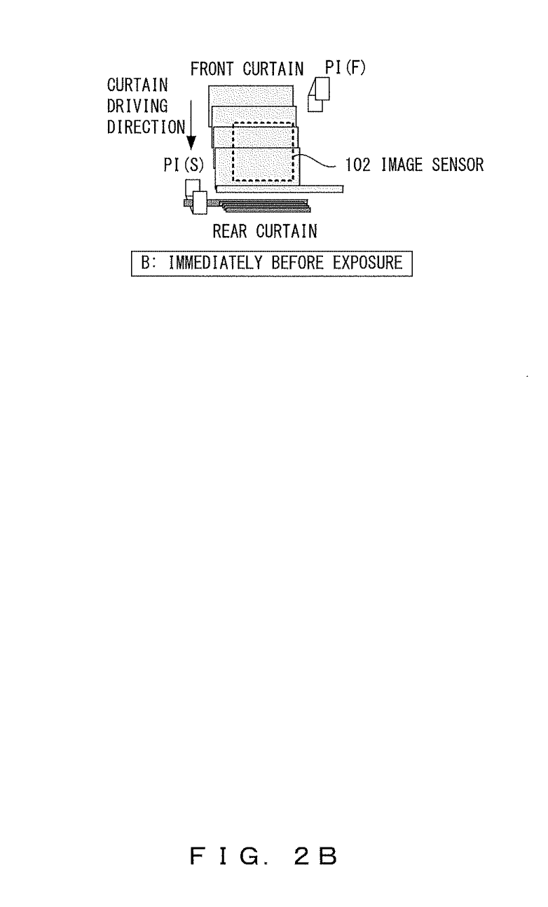

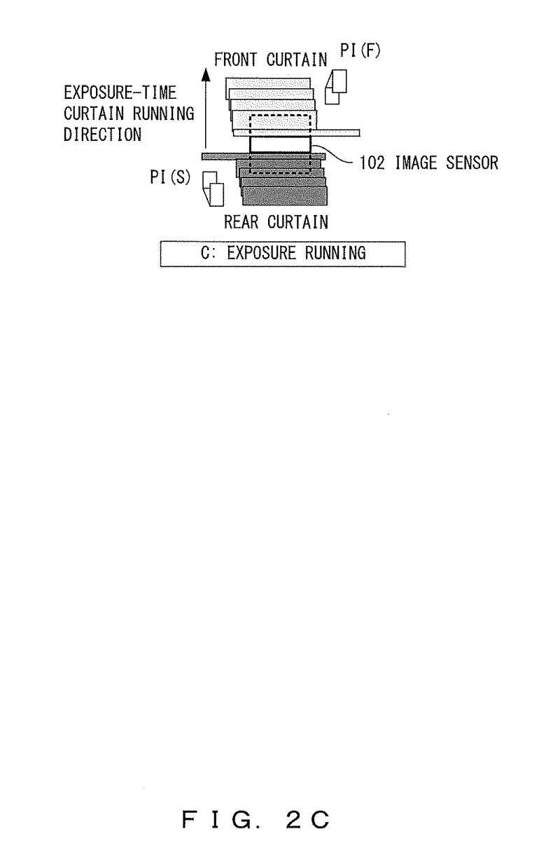

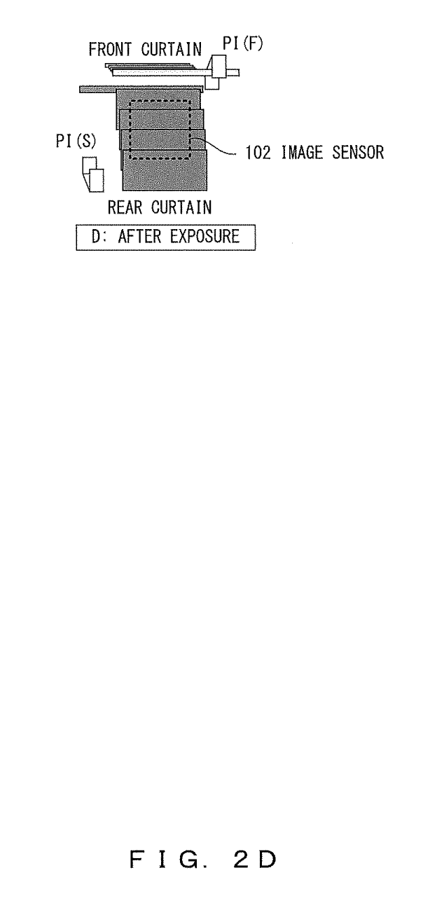

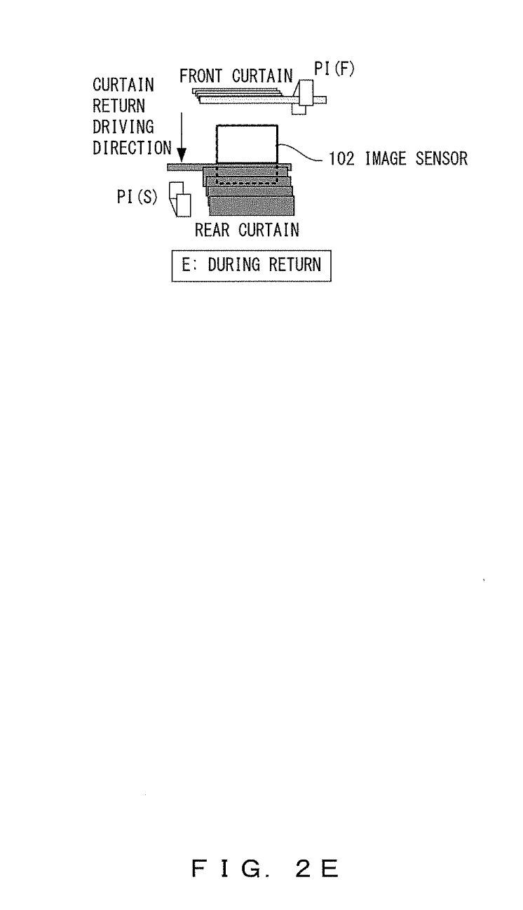

FIG. 2A, FIG. 2B, FIG. 2C, FIG. 2D, and FIG. 2E are diagrams explaining an example of a series of operations of the shutter unit 101 in which an exposure operation in still-image photographing is performed from a state in which the image sensor 102 is exposed and the image sensor 102 enters again into an exposed state.

FIG. 2A illustrates a state in which the shutter unit 101 is in the fully open state (hereinafter also referred to as “A: fully open”). In this state, the front curtain and the rear curtain are folded, and PI(F) and PI(S) are shielded from light. At this time, the image sensor 102 does not have any portions covered by the front curtain and the rear curtain, and the image sensor 102 is in the exposed state.

An aperture of the shutter unit 101 at the time when the front curtain and the rear curtain are open to a drivable range (namely, in the fully open state) is not determined by the front curtain and the rear curtain, but is determined by another member such as the exterior of the shutter unit 101. An aperture at this time is defined as an image frame, and the upper end and the lower end of the aperture are respectively defined as an image frame upper end and an image frame lower end.

FIG. 2B illustrates a state of the shutter unit 101 before the exposure operation in still-image photographing (hereinafter also referred to as “B: immediately before exposure”), and illustrates a state in which, before the exposure operation in still-image photographing, the front curtain is driven in a curtain driving direction (an arrow direction in FIG. 2B) and the image sensor 102 is shielded from light by the front curtain. In this state, only PI(S) remains shielded from light.

FIG. 2C illustrates the operation of the shutter unit 101 in still-image exposure (hereinafter also referred to “C: exposure running”). In still-image exposure, the front curtain opens in an exposure-time curtain running direction (an arrow direction in FIG. 2C) such that the image sensor 102 is exposed, and the rear curtain shields the image sensor 102 from light again. A time period during which the image sensor 102 is exposed is controlled by running start timings of the front curtain and the rear curtain in still-image exposure.

FIG. 2D illustrates a state of the shutter unit 101 after the completion of exposure (hereinafter also referred to as “D: after exposure”). In this state, the front curtain is fully open, and PI(F) is shielded from light. In addition, the image sensor 102 is shielded from light by the rear curtain.

FIG. 2E illustrates an operation to open the rear curtain (hereinafter also referred to as “E: during return”). In this operation, due to the movement of the rear curtain in a curtain return driving direction (an arrow direction in FIG. 2E), the image sensor 102 changes from a light-shielding state to an exposed state. In this operation, PI(F) remains shielded from light. When this operation is completed, the shutter unit 101 returns to the state of FIG. 2A (the state “A: fully open”).

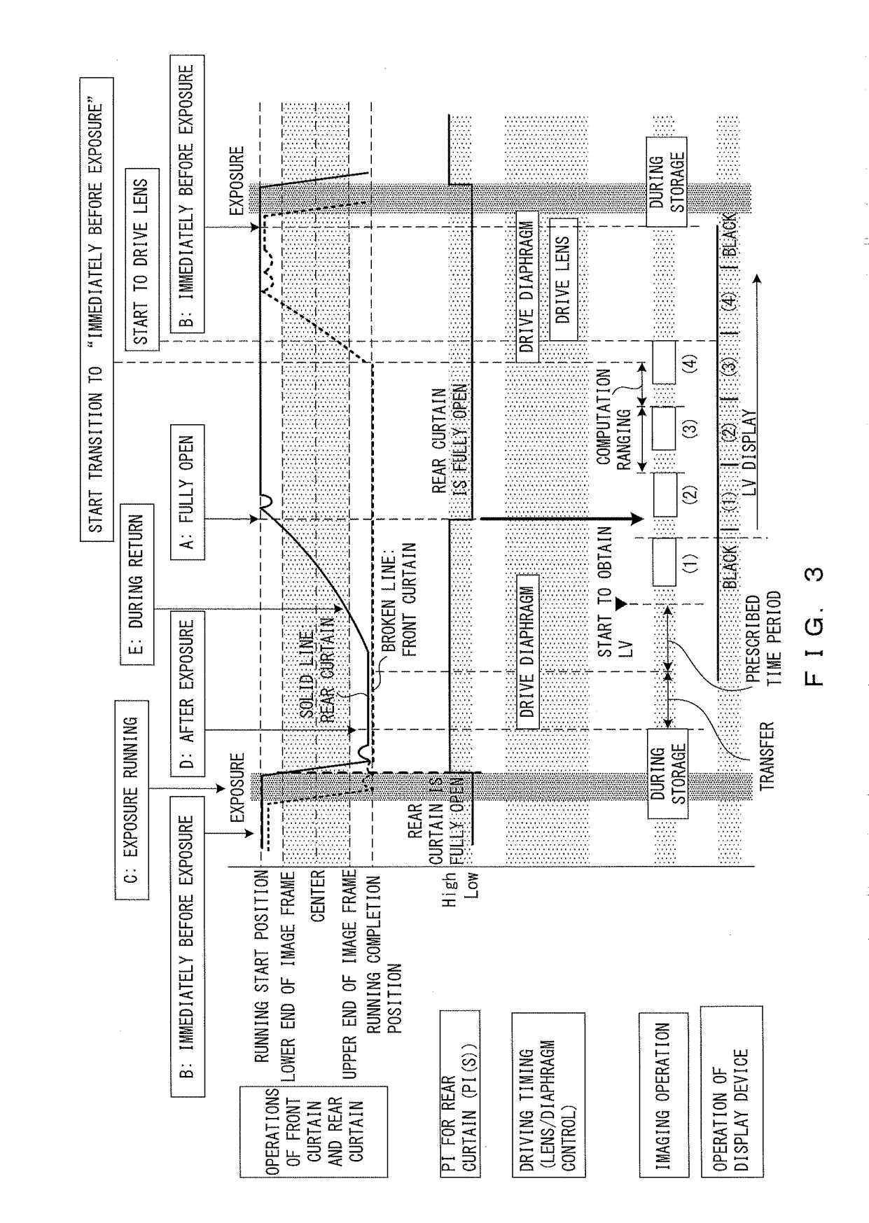

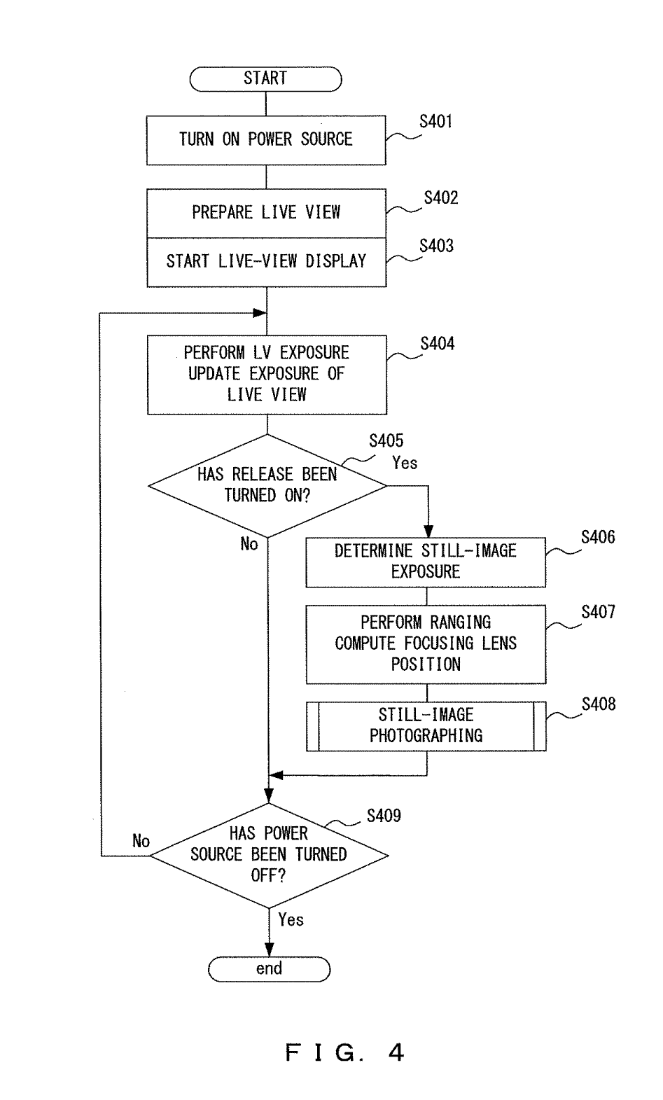

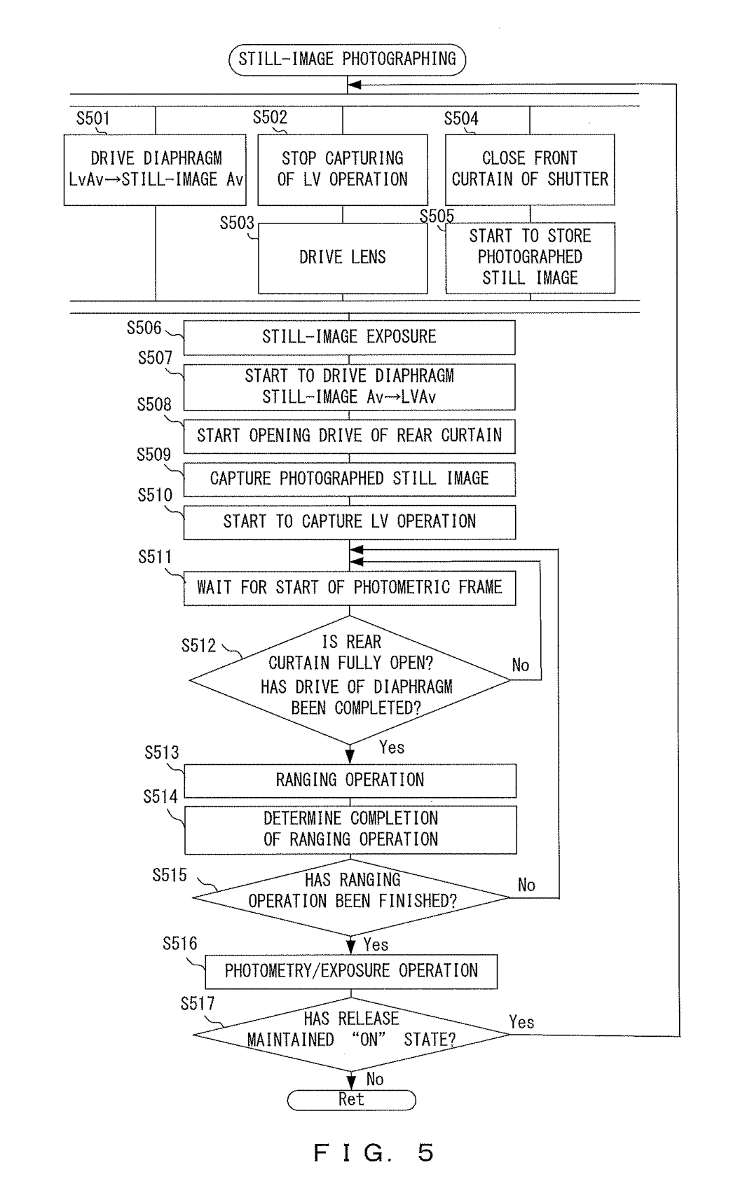

The operation of the camera according to this embodiment is described next with reference to a timing chart (FIG. 3) and flowcharts (FIG. 4 and FIG. 5).

FIG. 3 is a timing chart illustrating an example of the operation of the camera according to this embodiment.

FIG. 3 illustrates, in order from the top, the operations of the front curtain and the rear curtain in the shutter unit 101, a state (an output signal state) of PI(S) in the shutter unit 101, a driving timing for changing the diaphragm 202 and a focal position (the position of the photographing lens 201) of the lens unit 200, an imaging operation, and the operation of a display device.

In the operations of the front curtain and the rear curtain in FIG. 3, a broken line indicates the operation of the front curtain (the movement of the end of the front curtain), and a solid line indicates the operation of the rear curtain (the movement of the end of the rear curtain). “Running start position” indicates a curtain running start position at the time of exposure, and “running completion position” indicates a curtain running completion position at the time of exposure. “Center” indicates the center of an image frame.

In FIG. 3, assume that PI(S) outputs a Low signal when the rear curtain is in the fully open state (in a state in which PI(S) is shielded from light by a member provided at the end of the rear curtain), and that PI(S) outputs a High signal when the rear curtain is not in the fully open state. The display device is the rear liquid crystal monitor 106 or the EVF liquid crystal device 301 on which an LV display is performed.

In the operations of the front curtain and the rear curtain illustrated in FIG. 3, in the state “B: immediately before exposure”, the end of the front curtain and the end of the rear curtain are located outside the lower end of the image frame. In this state, the front curtain shields the image sensor 102 from light, and the rear curtain is in the fully open state. Then, “C: exposure running” is performed in order to obtain a still image. Here, the end of the front curtain is driven from a light-shielding position to a fully open position, and following the front curtain, the end of the rear curtain is driven from the fully open position to the light-shielding position. The temporary movement in a direction of the upper end of the image frame of the end of the front curtain and the end of the rear curtain after arrival at the running completion position indicates that the front curtain and the rear curtain rebound outside the image frame. At “D: after exposure”, the front curtain enters into the fully open state, and the rear curtain shields the image sensor 102 from light. Then, an operation to open the rear curtain (“E: during return”) is performed in order to perform an LV operation. A general focal-plane shutter plays a role in storing a force in an exposure direction (an exposure-time curtain running direction) in a spring or the like, and therefore a torque is needed. This is applied to the shutter unit 101 in which a curtain is driven according to a general method using a spring. Therefore, “E: during return” in FIG. 3 also indicates that the speed of driving back is lower than the speed in the exposure direction. Then, the rear curtain reaches the lower end of the image frame and enters into the state “A: fully open”, and returns to “B: immediately before exposure”, as illustrated in FIG. 3. The temporary movement in a direction of the lower end of the image frame of the end of the front curtain and the end of the rear curtain after a return to the running start position indicates that the front curtain and the rear curtain rebound outside the image frame.

In the state of PI(S) illustrated in FIG. 3, at “B: immediately before exposure”, the rear curtain is in the fully open state, and therefore an output of PI(S) becomes a Low signal. After exposure, the output of PI(S) becomes a High signal at a timing at which the rear curtain starts to shield the image sensor 102 from light, and the output of PI(S) becomes a Low signal again in the state “A: fully open”. In this embodiment, the front curtain is configured to maintain the fully open state after “D: after exposure” and before “B: immediately before exposure”. By doing this, during this period, when the rear curtain enters into the fully open state, the shutter unit 101 also enters into the fully open state, and therefore description of the state of PI(F) is omitted in FIG. 3.

In a case in which a shutter unit in which, after the front curtain enters into the fully open state after exposure, the front curtain may enter again within the image frame and a portion of the front curtain may shield the image sensor 102 from light is employed as the shutter unit 101, a timing of “A: fully open” is a timing at which a state in which both PI(F) and PI(S) are shielded (a Low-signal output state) is detected.

In the driving timing illustrated in FIG. 3, after exposure, the diaphragm 202 is driven from an aperture value for still-image photographing (for still-image exposure) to an aperture value for the LV operation. It is preferable that the depth of field be shallow in order to perform AF after exposure. Therefore, in the drive to the aperture value for the LV operation, the diaphragm 202 is basically driven to an open side. In an operation from the LV operation to still-image photographing, when the aperture value is changed from the aperture value for the LV operation to the aperture value for still-image photographing, basically, an operation to increase or decrease the size of an aperture of the diaphragm 202 is performed. The photographing lens 201 is driven to a lens position determined according to a ranging result in the LV operation. In practice, in a case in which a focal position moves according to an aperture value, the photographing lens 201 is driven in such a way that the lens position is corrected according to the aperture value. However, driving of a lens for correction is performed to maintain the focal position, and therefore, in this embodiment, it is assumed that driving of the lens is not performed during the driving of a diaphragm, and the driving of the lens is not illustrated in FIG. 3.

In the imaging operation illustrated in FIG. 3, the image sensor 102 sweeps out all of the electric charges stored in pixels at “B: immediately before exposure”, and the shutter unit 101 stores electric charges that correspond to an amount of light that enters when the shutter unit 101 is opened. After “C: exposure running”, the electric charges stored in the pixels are transferred, and a still image is generated by the image processing IC 104. After a prescribed time period has passed, the continuous capturing of the LV operation (the continuous capturing of a signal from the image sensor 102) is started regardless of whether the shutter unit 101 is fully open. The prescribed time period is set to a waiting time needed to match a display cycle of the display device described later and a periodical timing of capturing from the image sensor 102. Stated another way, at a timing at which an image is generated by the image processing IC 104 on the basis of an output of the image sensor 102, the image is immediately displayed on the display device. A number in parentheses illustrated in FIG. 3 indicates a correspondence between a frame of the image sensor 102 (an imaging frame) and a frame of the display device (a display frame).

In the operation of the display device illustrated in FIG. 3, the display device displays (LV-displays) an image generated from an image formed on the image sensor 102 in a prescribed cycle. When there are no images, a black display is conducted.

Here, a relationship among PI(S), the imaging operation, and the ranging operation illustrated in FIG. 3 is described.

In FIG. 3, at “D: after exposure”, the rear curtain starts to open from the light-shielding state in order to return to the LV operation, but the LV display has already been started before “A: fully open”. In frames (1) and (2), a portion of the rear curtain shields the image sensor 102 from light, and an image in which a portion of the subject is dark is displayed on the display device. However, even if a frame at the time when a portion is shielded from light is output (displayed) from a blackout (a black display), when a frame at the time when the shutter unit 101 is fully open is displayed thereafter, a change in brightness goes in one direction (a direction from shade to light). Therefore, this does not cause a user to feel discomfort, and in a case in which a subject is traced while viewing a display image, a reduction in image loss is advantageous. However, ranging by using a frame (a frame image) at the time when a portion is shielded from light is not performed.

After “A: fully open”, frame (3) obtained after the output of PI(S) becomes a Low signal can be used in ranging. In this embodiment, assume that an image sensor including pixels for which a phase difference can be obtained (an image sensor having a phase difference AF function) is employed as the image sensor 102. By doing this, when the image processing IC 104 processes a frame image of frame (3), a focusing state and a focusing position of the photographing lens 201 can be computed from an output of the phase difference. When computation has been successfully completed, the front curtain starts to be driven in a direction in which the image sensor 102 is shielded from light in preparation for the next still-image photographing (see “start transition to ‘immediately before exposure’”). At this time, the diaphragm 202 may be driven. In this case, at a point in time at which the computation above has been completed, frame (4) in the process of being captured becomes a frame image in which a portion is shielded from light. However, even if a dark image is displayed by reducing the size of an aperture of the diaphragm 202, a display gradually becomes darker until blackout (a black display) is reached at “B: immediately before exposure”, and therefore this does not cause discomfort in appearance. After the computation above, after completion of the capturing of frame (4) that was in the process of being captured, the continuous capturing of the LV operation is terminated. After the termination of capturing, the photographing lens 201 is driven (see “start to drive lens” in FIG. 3). This is because a frame captured during the driving of a lens has a problem in appearance, and the frame captured during the driving of the lens is not displayed.

FIG. 4 is a flowchart illustrating an example of the operation of the camera according to this embodiment.

As illustrated in FIG. 4, in step (hereinafter simply referred to as “S”) 401, when a power source of the camera is turned on by operating a power switch of the camera operation switch 112, power is supplied to an electric circuit within the camera. By doing this, the control microcomputer 110, the image processing IC 104, the image sensor driving IC 103, and the like are started, and the image sensor 102, the lens unit 200, the EVF unit 300, and the like are initialized.

In S402, live-view preparatory processing is performed. In a live view, an amount of light that enters the image sensor 102 is adjusted according to a sensitivity of the image sensor 102 (hereinafter also referred to as an “imaging sensitivity”), the speed of an electronic shutter, and a diaphragm position (the position of the diaphragm 202) within the lens unit 200, but a luminance of the subject is not clear at the time when the live view is started. Therefore, in the live-view preparatory processing, LV photometry is performed according to an imaging output (an output from the image sensor 102 and the image sensor driving IC 103) in the setting of a prescribed imaging sensitivity, a prescribed speed of the electronic shutter, and a prescribed diaphragm position, and the exposure of a start frame of the live view is determined according to the obtained photometric value.

In S403, a live-view display is started. By doing this, a user can confirm a subject image by viewing the eyepiece 303 of the EVF unit 300, and can also confirm the subject image by viewing the rear liquid crystal monitor 106.

In S404, LV photometry is performed, and control is performed to update exposure according to the obtained photometric value in such a way that the exposure of the live view becomes a target exposure.

In S405, it is determined whether a release has been turned on by operating a release switch of the camera operation switch 112.

When the determination result in S405 is Yes, the processes of S406 to S408 are performed, and the processing moves on to S409. When the determination result in S405 is No, the processing moves on to S409.

In S406, still-image exposure is determined. More specifically, an aperture value, a shutter speed, and an imaging sensitivity in still-image photographing are determined according to the photometric value obtained in S404.

In S407, a focusing state is computed (ranging is performed) from a frame image of the live view, and the position of the photographing lens 201 in still-image photographing is computed.

In S408, still-image photographing processing is performed. Details of this processing will be described later with reference to FIG. 5.

In S409, it is determined whether the power source of the camera has been turned off by operating the power switch of the camera operation switch 112.

When the determination result in S409 is No, the processing returns to S404, and when the determination result in S409 is Yes, the operation of the camera is terminated.

In the operation above illustrated in FIG. 4, unless the release is turned on, LV photometry and the updating of the exposure of the live view (S404) are periodically repeated, and control is performed in such a way that a target exposure is always achieved.

FIG. 5 is a flowchart illustrating an example of still-image photographing processing (S408).

As illustrated in FIG. 5, when still-image photographing processing is started, first, the process of S501, the process of S502, and the process of S504 are simultaneously started, and the process of S501, the processes of S502 and S503, and the processes of S504 and S505 are performed in parallel. After the process of S501, the process of S503, and the process of S505 are finished, the processing moves on to S506. This processing procedure is illustrated in FIG. 5 by sandwiching the process of S501, the processes of S502 and S503, and the processes of S504 and S505 that are performed in parallel with upper and lower parallel double lines.

In S501, a diaphragm is driven. Here, a diaphragm is driven in order to change from an aperture value in the live view (LvAv) to an aperture value in still-image photographing (still-image Av) that is determined in S406 described above or S516 described later.

In S502, the capturing of the LV operation is terminated.

In S503, the photographing lens 201 is driven to the lens position computed in S407 described above or S513 described later in order to bring a still image into focus. Here, while a continuous photographing operation is continued, when the ranging operation of S513 described later is finished (S515: the ranging operation has been finished), the image sensor may be performing imaging. In this case, after an output of the image sensor of a corresponding frame is obtained, the driving of a focus lens in S503 is started, and a live-view display is performed according to the obtained output of the frame (FIG. 3). Alternatively, after photometry and an exposure operation in S516 described later are performed, the image sensor may be performing imaging. Also in this case, an output of the image sensor of a corresponding frame is obtained, and a live-view display is performed according to the obtained output of the frame. Even before the obtainment of an output of the entirety of one frame of the image sensor is completed, image processing may be performed in a state in which a portion of the output (for example, an output that corresponds to a plurality of lines) has been obtained, and a live-view display may be started.

In S504, the front curtain of the shutter unit 101 is closed, and the image sensor 102 is shielded from light by the front curtain.

In S505, electric charges stored in the image sensor 102 in the light-shielding state are swept out, and the camera enters into a state in which electric charges are stored that correspond to an amount of light that enters the image sensor 102 while the shutter unit 101 is open (a state in which the storage of a captured still image is started).

In S506, still-image exposure is performed. Here, the front curtain that has shielded the image sensor 102 from light is first opened, and after an exposure time needed for the still-image exposure determined in S406 has passed, the rear curtain of the shutter unit 101 shields the image sensor 102 from light again.

In S507, the driving of a diaphragm is started. Here, the driving of the diaphragm is started in order to change from an aperture value in still-image photographing (still-image Av) to an aperture value in a live view (LvAv).

In S508, an operation to open the rear curtain of the shutter unit 101 (the opening driving of the rear curtain) is started.

In S509, a photographed still image is captured. More specifically, an output of the image sensor 102 in a state in which the image sensor 102 is shielded from light by the rear curtain is transferred to the image processing IC 104 via the image sensor driving IC 103. Then, the image processing IC 104 converts the output into an image, and records the image in the recording medium 109 via the communication connector 108.

In S510, the capturing of the LV operation is started. The capturing of the LV operation is started at a timing that matches a driving cycle of the display device such that an image is displayed immediately after capturing.

In S511, the start of the capturing of a frame to be used in ranging is awaited. As an example, when the speed of continuous photographing is increased, the start of the capturing of the first frame after the start of the capturing of the LV operation may be awaited. Alternatively, when the speed of continuous photographing is reduced, the camera may wait during a prescribed time period in order to increase a continuous photographing interval, may await the start of the capturing of a frame to be captured next, and may perform ranging by using a frame closest to a frame in the next still-image photographing.

In S512, it is determined whether the rear curtain is in the fully open state and whether the driving of the diaphragm started in S507 has been completed. In this determination, it can be determined whether an image to be formed on the image sensor 102 is an image that has been captured when the diaphragm is in a state according to the aperture value in the live view (LvAv) and when the shutter unit 101 is in the fully open state.

In S511 and S512, a start timing of the capturing of a frame may be a timing immediately before a timing at which the image sensor 102 starts integration. Alternatively, a vertical synchronizing signal of the image sensor 102, which is a start point of a frame, may be used as the start timing of the capturing of the frame.

When the determination result in S512 is No, the processing returns to S511, and when the determination result in S512 is Yes, the processing moves on to S513.

In S513, a ranging operation is performed by using a frame captured after the determination result in S512 becomes Yes. In this embodiment, the image sensor 102 is an image sensor including pixels for which a phase difference can be obtained, and therefore a focusing state of the subject is obtained in a single frame. An amount of the driving of a lens needed to make the subject in-focus (an amount of the driving of the photographing lens 201) is calculated according to the obtained focusing state. The amount of the driving of the lens is also an amount of the driving of the lens to a lens position that makes the subject in-focus.

When a manual focusing mode has been set by operating the camera operation switch 112 and a user manually performs focusing, a frame used in ranging and the ranging operation are not needed. However, also in this case, a single frame after the rear curtain is fully opened may be obtained such that the appearance of a display during continuous photographing is equivalent to the appearance during ranging.

In S514, it is determined whether the ranging operation of S513 has been successfully completed (finished). More specifically, it is determined whether the shutter unit 101 has maintained the fully open state (whether PI(S) has maintained the light-shielding state) and whether a normal focusing state has been detected in the ranging operation of S513.

In S515, it is determined from the determination result of S514 whether the ranging operation of S513 has been successfully completed (finished). More specifically, it is determined from the determination result of S514 whether the shutter unit 101 has maintained the fully open state (whether PI(S) has maintained the light-shielding state) and whether a normal focusing state has been detected in the ranging operation of S513.

When the manual focusing mode has been set, it is only determined in S514 whether the shutter unit 101 has maintained the fully open state (whether PI(S) has maintained the light-shielding state), and it is only determined in S515 from the determination result of S514 whether the shutter unit 101 has maintained the fully open state (whether PI(S) has maintained the light-shielding state).

When the determination result of S515 is No, the processing returns to S511, and when the determination result of S515 is Yes, the processing moves on to S516.

In S516, a photometric value is computed according to the output (a still image) of the image sensor 102 obtained in S509, and an aperture value, a shutter speed, and an imaging sensitivity in still-image photographing of the next frame are determined. The aperture value may be computed according to a frame captured after the determination result of S512 becomes Yes. In S516, subject analysis such as person recognition may be further performed by using the frame captured after the determination result of S512 becomes Yes.

In S517, it is determined whether the release has maintained the ON state.

When the determination result in S517 is Yes, the processing returns to S501, S502, and S504, and when the determination result in S517 is No, the still-image photographing processing returns.

In the still-image photographing processing above of FIG. 5, while the release maintains the ON state, still-image photographing is repeated (continuous photographing is performed).

As described above, according to the first embodiment, by including a sensor (PI(F) and PI(S)) that detects that the shutter unit 101 is in the fully open state and appropriately cooperating with imaging control, improvements in the speed of continuous photographing and a reduction in image loss are achieved, and ranging (photometry, subject analysis, and the like as needed) can be reliably performed.

### Second Embodiment

An imaging device according to a second embodiment of the present invention is different from the imaging device according to the first embodiment in a portion of still-image photographing processing. Accordingly, in the description of the second embodiment, differences are principally described, and the same components as the components described in the first embodiment are described by using the same reference numerals.

In still-image photographing processing according to the second embodiment, the determination of whether a ranging operation has been successfully completed (finished) is performed, for example, by calculating a time.

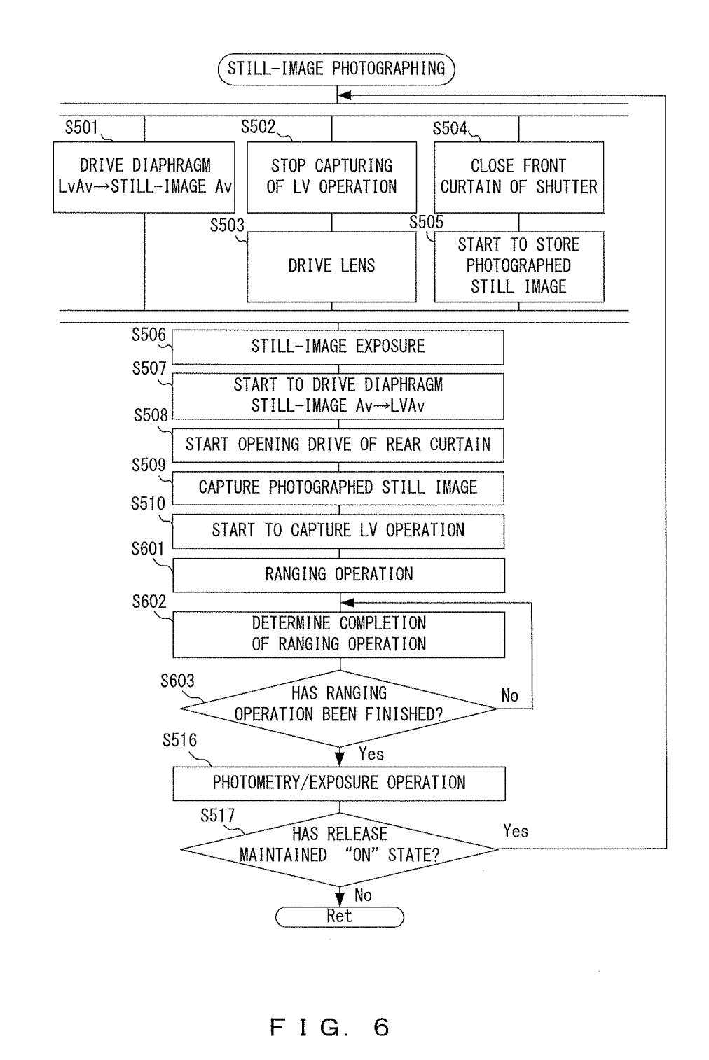

FIG. 6 is a flowchart illustrating an example of the still-image photographing processing according to the second embodiment.

As illustrated in FIG. 6, in the still-image photographing processing according to the second embodiment, first, the processes of S501 to S510 are performed similarly to the still-image photographing processing according to the first embodiment (see FIG. 5). However, in S503 of the second embodiment, the photographing lens 201 is driven to a lens position computed in S407 described above (see FIG. 4) or S601 described later in order to bring a still image into focus.

After S510, the processes of S601 to S603 are performed.

In S601, a ranging operation is performed by using a frame captured when the rear curtain is in the fully open state in the capturing of the frame. Also in the second embodiment, the image sensor 102 is an image sensor including pixels for which a phase difference can be obtained, and therefore a focusing state of a subject is obtained in a single frame, and an amount of the driving of a lens (an amount of the driving of the photographing lens 201) that is needed to make the subject in-focus is calculated according to the focusing state. The amount of the driving of the lens is also an amount of the driving of the lens to a lens position that makes the subject in-focus.

In S602, it is determined whether the ranging operation of S601 has been successfully completed (finished). More specifically, by calculating a time, it is determined whether the rear curtain is in the fully open state (whether PI(S) is in the light-shielding state) and whether the driving of a diaphragm started in S507 has been completed at the timing of the capturing of a frame used in the ranging operation of S601.

Specifically, when relational expression (1) described below is satisfied at a point in time at which the ranging operation of S601 is completed, it is determined that the rear curtain is in the fully open state (PI(S) is in the light-shielding state) at the timing of the capturing of a frame used in the ranging operation of S601.

Ta>Tb (1)

In this relational expression, Ta is a time period that has passed after an output of a Low signal of PI(S) was detected.

Tb is the total time of a time needed to capture a frame used in the ranging operation and a ranging operation time.

Relational expression (1) is satisfied when a time period from the start of the capturing of a frame used in the ranging operation to the present time is shorter than a time period from a point in time at which the rear curtain enters into the fully open state to the present time. In this case, it is determined that the rear curtain is in the fully open state (PI(S) is in the light-shielding state) at a timing at which a frame used in the ranging operation of S601 is captured.

The time needed to capture a frame used in the ranging operation of Tb may be a time period from a timing immediately before a timing at which the image sensor 102 starts integration to the end of the capturing of the frame. Alternatively, more flexibly, a vertical synchronizing signal of the image sensor 102, which is a start point of a frame, may be a start timing of the capturing of the frame. The ranging operation time is a time period from the end of the capturing of a frame used in the ranging operation to a start time of the determination of whether the ranging operation has been successfully completed (finished) (the determination start time of S602). When a time margin is provided to the determination start time in consideration of a time measurement error or the like, Tb may be a time obtained by further adding the time margin.

In addition, the determination of whether the driving of the diaphragm started in S507 has been completed can be performed similarly by counting a time from the completion of the driving of the diaphragm to the present time.

Further, in S602, it is also determined whether a focusing state has been successfully detected in S601.

In S601 and S602, when a manual focus mode has been set and a frame used in the ranging operation is not needed, it is determined considering the appearance of the display during the continuous photographing that the ranging operation has been successfully completed (finished) after one frame after the rear curtain was fully opened is obtained. In this case, when relational expression (2) described below is satisfied, it is determined that the ranging operation has been successfully completed (finished).

Ta>Tc (2)

In this relational expression, Ta is as described above, and Tc is the time needed to capture a single frame.

Relational expression (2) is different from relational expression (1) in that the right side does not include a ranging operation time, but Tc may be a time obtained by further adding a fixed time equivalent to the ranging operation time in order to make a display during continuous photographing appear similar to the display in a case in which the ranging operation is performed.

In S603, it is determined from the determination result of S602 whether the ranging operation has been successfully completed (finished). More specifically, it is determined from the determination result of S602 whether the rear curtain is in the fully open state (whether PI(S) is in the light-shielding state) and whether the driving of the diaphragm started in S507 has been completed at the timing of the capturing of a frame used in the ranging operation in S601, and whether a focusing state has been successfully detected in S601.

When the determination result of S603 is No, the processing returns to S601.

When the determination result of S603 is Yes, the processes of S516 and S517 are performed similarly to the still-image photographing processing according the first embodiment (see FIG. 5).

According to the second embodiment in which the still-image photographing processing above is performed, effects similar to those in the first embodiment can be achieved.

In the first and second embodiments described above, the shutter unit 101 is not limited to a focal-plane mechanical shutter, and a mechanical shutter of another type may be employed.

The present invention is not limited to the embodiments above with no change, and in an implementing stage, components can be varied and embodied without departing from the gist of the embodiments above. Various inventions can be made by appropriately combining a plurality of components disclosed in the embodiments above. As an example, some of the components disclosed in the embodiments may be deleted. Further, components disclosed in different embodiments may be appropriately combined.

What is claimed is:

1. An imaging device that includes an image sensor that forms an image with light from a subject by using a photographing lens, converts the formed image into an electrical signal, and outputs the electrical signal, and a display device that performs a live-view display according to an output of the image sensor, the imaging device comprising:
a mechanical shutter that controls the image sensor to be in a light-shielding state or in an exposed state;
a fully open detection sensor that detects that the mechanical shutter is in a fully open state;
a ranging operation circuit that performs a ranging operation according to the output of the image sensor; and
a control circuit that controls the image sensor and the mechanical shutter to photograph a still image and image a live view, wherein
the control circuit controls the image sensor to start imaging of the live view after photographing the still image, and the ranging operation circuit performs the ranging operation by using the output of the image sensor obtained by imaging the live view after the fully open detection sensor has detected that the mechanical shutter is in the fully open state.

2. The imaging device according to claim 1, wherein
the control circuit starts control to close the mechanical shutter after the ranging operation circuit performs the ranging operation, when the still image is consecutively photographed.

3. The imaging device according to claim 1, further comprising:
a diaphragm that adjusts an aperture of the photographing lens, wherein
the control circuit performs control to start a driving of the diaphragm after the ranging operation circuit performs the ranging operation, when the still image is consecutively photographed.

4. The imaging device according to claim 1, wherein
the control circuit controls the display device to display the live view according to the output of the image sensor even while the image sensor is performing imaging, after the ranging operation circuit performs the ranging operation.

5. The imaging device according to claim 4, wherein
the photographing lens includes a focus lens that adjusts a focus, and
the control circuit performs control to drive the focus lens after the output of the image sensor is obtained.

6. The imaging device according to claim 1, wherein
the control circuit performs control to start the imaging of the live view after a prescribed time period has passed after the photographing of the still image, and sets the prescribed time period according to a display timing of the display device.

7. An imaging device that includes an image sensor that forms an image with light from a subject by using a photographing lens, converts the formed image into an electrical signal, and outputs the electrical signal, and a display device that performs a live-view display according to an output of the image sensor, the imaging device comprising:
a mechanical shutter that controls the image sensor to be in a light-shielding state or in an exposed state;
a fully open detection sensor that detects that the mechanical shutter is in a fully open state;
a photometric operation circuit that measures brightness of the subject according to the output of the image sensor; and
a control circuit that controls the image sensor and the mechanical shutter to photograph a still image and image a live view, wherein
the control circuit controls the image sensor to start imaging of the live view after photographing the still image, and the photometric operation circuit performs the photometric operation by using the output of the image sensor obtained by imaging the live view after the fully open detection sensor has detected that the mechanical shutter is in the fully open state.

8. The imaging device according to claim 7, wherein
the control circuit starts control to close the mechanical shutter after the photometric operation circuit performs the photometric operation, when the still image is consecutively photographed.

9. The imaging device according to claim 7, further comprising:
a diaphragm that adjusts an aperture of the photographing lens, wherein
the control circuit performs control to start a driving of the diaphragm after the photometric operation circuit performs the photometric operation, when the still image is consecutively photographed.

10. The imaging device according to claim 7, wherein
the control circuit controls the display device to display the live view according to the output of the image sensor even while the image sensor is performing imaging, after the photometric operation circuit performs the photometric operation.

11. The imaging device according to claim 10, wherein
the photographing lens includes a focus lens that adjusts a focus, and
the control circuit performs control to drive the focus lens after the output of the image sensor is obtained.

12. The imaging device according to claim 11, wherein
the control circuit performs control to start the imaging of the live view after a prescribed time period has passed after the photographing of the still image, and sets the prescribed time period according to a display timing of the display device.

13. A method for controlling an imaging device that includes an image sensor that converts a subject image formed by a photographing lens into an electrical signal and outputs the electrical signal, a mechanical shutter that controls the image sensor to be in a light-shielding state or in an exposed state, and a display device that performs a live-view display according to an output of the image sensor, the method comprising:
starting, by the image sensor, imaging of a live view after photographing a still image;
detecting that the mechanical shutter is in a fully open state, after the starting; and
performing a ranging operation or a photometric operation according to the output of the image sensor obtained by imaging the live view, after the detecting.

14. A non-transitory computer-readable recording medium storing a program for causing a computer of an imaging device to perform a process, the imaging device including an image sensor that converts a subject image formed by a photographing lens into an electrical signal and outputs the electrical signal, a mechanical shutter that controls the image sensor to be in a light-shielding state or in an exposed state, and a display device that performs a live-view display according to an output of the image sensor, the process comprising:
starting, by the image sensor, imaging of a live view after photographing a still image;
detecting that the mechanical shutter is in a fully open state, after the starting; and
performing a ranging operation or a photometric operation according to the output of the image sensor obtained by imaging the live view, after the detecting.
